(19) United States
(12) Patent Application Publication
(10) Pub. No.: US 2024/0239440 A1
(43) Pub. Date: Jul. 18, 2024

(54) MOTORCYCLE WITH EASILY REMOVABLE WHEEL PROVIDED WITH HUB MOTOR

(71) Applicant: PIAGGIO & C. SPA, Pontedera (IT)

(72) Inventor: Emiliano GUIDI, Pontedera (IT)

(21) Appl. No.: 18/562,627

(22) PCT Filed: May 16, 2022
(86) PCT No.: PCT/IB2022/054530

§ 371 Date: Nov. 20, 2023

(30) Foreign Application Priority Data
May 25, 2021 (IT) 102021000013577

(51) Int. Cl. B62M 7/12; B62J 15/00; B62J 43/16; B62K 25/28; B62L 1/00

(52) U.S. Cl. CPC B62M 7/12; B62J 43/16; B62K 25/283; B62L 1/005; B62J 15/00; B62K 2202/00

(57) ABSTRACT

A motorcycle, including a rear wheel with a hub motor, having a hub motor axis with first and second opposite end portions, and a swingarm including a first and second arms, where the first and second arms include first and second coupling recesses, respectively, which are configured to receive the first and second end portions of the hub motor axis, respectively, and have each an open side to allow to uncouple the hub motor axis from the swingarm and remove the wheel from the motorcycle, where the first and second coupling recesses have a main extension direction, where the motorcycle may include a disc brake (5, 6) arranged on the side of the first arm of the swingarm, where the disc brake (5, 6) includes a braking disc rotationally integral with the wheel and a brake caliper fixed to the swingarm where, the brake caliper is angularly spaced about the motor axis on the hub relative to the main extension direction so as to allow removing the wheel from the motorcycle without the brake disc mechanically interfering with the brake caliper, where the motorcycle may also include a fender associated with the rear wheel either in addition or as alternatively to the disc and where the main extension direction is such as to allow to remove the wheel from the motorcycle without the wheel mechanically interfering with the fender.

### TECHNICAL FIELD OF THE DISCLOSURE

The present description relates to the technical field of motorcycles comprising at least one wheel provided with a hub motor.

### BACKGROUND OF THE DISCLOSURE

Motorcycles having a rear wheel equipped with a hub motor, in which said wheel is mounted to a double-arm swingarm, are known. In the known motorcycles of the aforementioned type, the removal of the rear wheel with hub motor, by way of non-limiting example when a tire must be changed, is relatively complicated.
to the disclosure makes available a motorcycle comprising a rear wheel provided with a hub motor which can either avoid or reduce at least in part the drawbacks discussed above with reference to the prior art.

In particular, the present disclosure provides a motorcycle comprising a rear wheel with a hub motor mounted to a double-arm swingarm, which makes it possible to simplify the wheel removal compared to solutions of the prior art.

Known examples of solutions in which a mounted rear wheel with a hub motor is installed on a swingarm of a motorcycle are provided in WO2012011767A2 or CN111409754A.

### BRIEF DESCRIPTION OF THE DRAWINGS

The disclosure will be better understood from the following detailed description of its embodiments, made by way of example and consequently not limiting in any manner with reference to the accompanying drawings, in which:

FIG. 1 shows a plan side view of the right side of a motorcycle according to a currently preferred embodiment;

FIG. 2 shows a plan side view of the left side of the motorcycle in FIG. 1;

FIG. 3 shows a plan side view of a motorcycle part of FIG. 1 shown from the side of FIG. 1, in which the motorcycle part comprises a rear wheel mounted to a swingarm;

FIG. 4 shows a plan side view similar to FIG. 3 in which some elements have been removed;

FIG. 5 shows a part of the motorcycle of FIG. 1 represented by the side of FIG. 2;

FIG. 6 shows a partially exploded perspective view of the part of the motorcycle shown in FIG. 3, in which, in particular, the rear wheel of the motorcycle is uncoupled from the swingarm;

FIG. 7 shows a plan side view similar to FIG. 3, in which some elements have been removed and in which the rear wheel of the motorcycle is uncoupled from the swingarm;

FIG. 8 shows a perspective view of the motorcycle of FIG. 1 shown from the side of FIG. 2, in which some elements have been removed and in which the rear wheel has been removed and arranged at the side of the motorcycle.

### DETAILED DESCRIPTION

Equal or similar elements are indicated with the same reference numerals in the accompanying drawings.

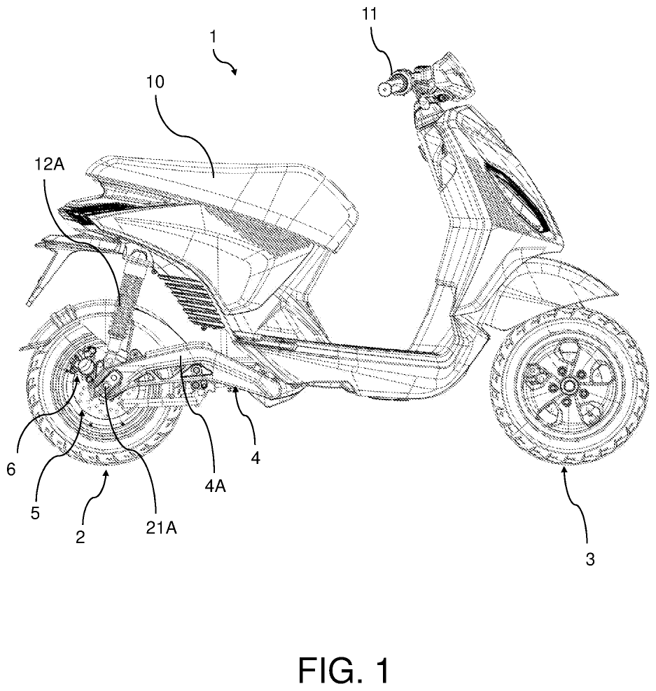

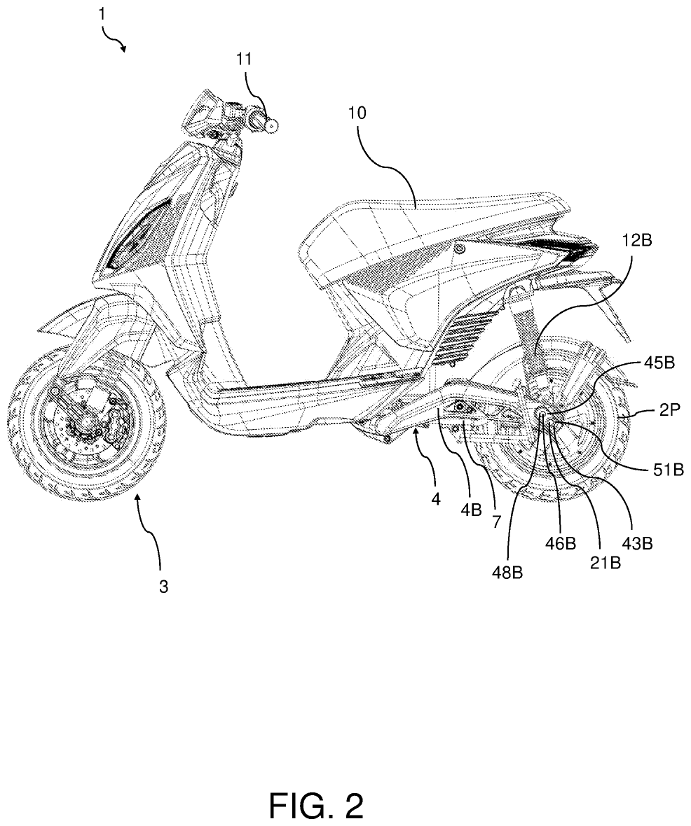

With reference to FIGS. 1-2, a motorcycle according to a currently preferred embodiment is globally indicated by reference numeral 1. In the particular example represented in FIGS. 1-2, the motorcycle 1 is a scooter 1, without because of this introducing any limitation. In the illustrated example, the motorcycle 1 comprises two wheels, specifically a rear wheel 2 and a front wheel 3. However, it is worth noting that for the purposes of this description, the term “motorcycle” must be interpreted broadly, including in said definition also motorcycles having three wheels, e.g., such as two paired and steered wheels on the front and one driving wheel on the rear. In a manner known in itself, the motorcycle 1 comprises a seat 10 astride which a user of the motorcycle may sit and a steering handlebar 11 operatively connected to the front wheel 3.

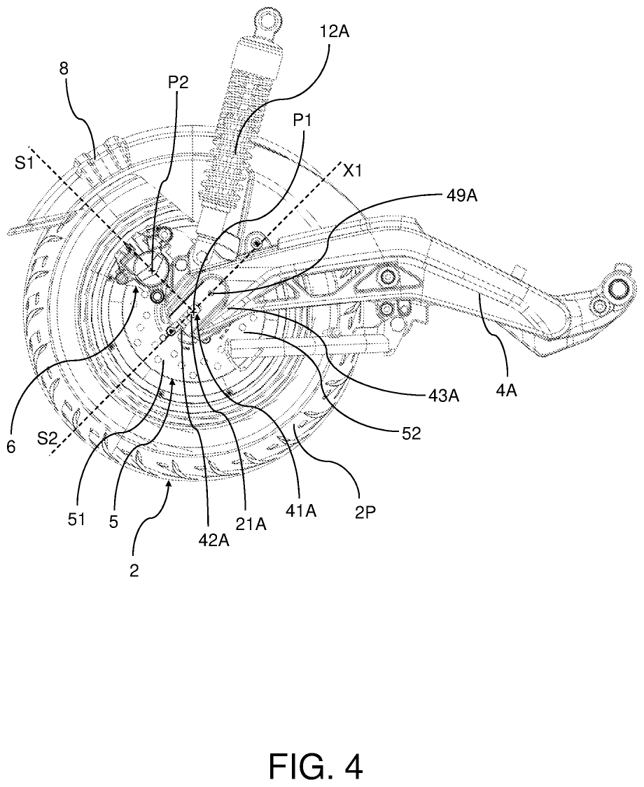

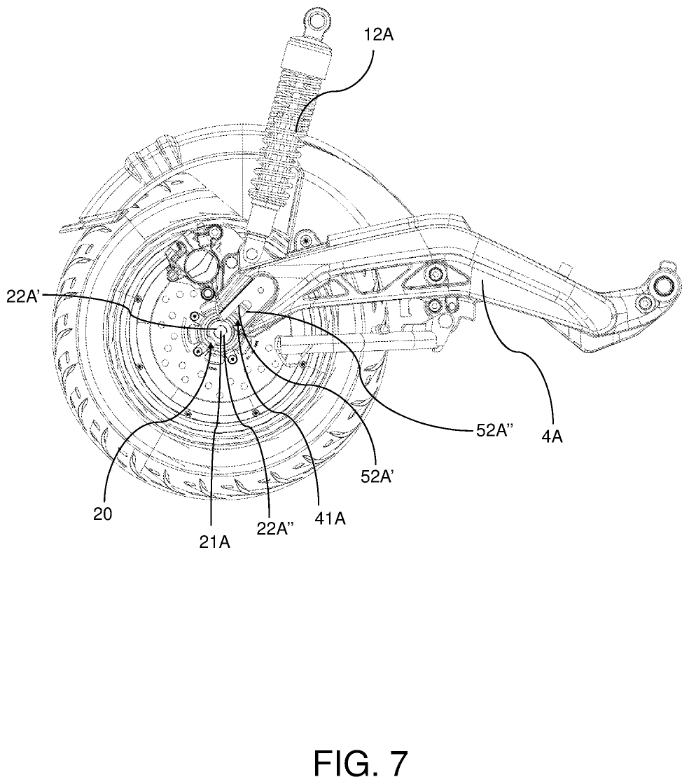

With reference to FIGS. 4, 5, and 8, the rear wheel 2 of the motorcycle 1 is provided with a hub motor 20. As known, a hub motor 20 is an electric motor which is installed in the hub 19 of the wheel 2 making it a drive wheel. The hub motor 20 (FIG. 7) comprises a hub motor axis 21 having a first and second opposite end portions 21A, 21B. The axis 21 is a fixed axis, i.e., non-rotating. The motorcycle 1 further comprises a swingarm 4 comprising a first and a second arm 4A, 4B. In other words, the swingarm 4 is a double-armed swingarm. According to an embodiment, the motorcycle 1 comprises at least one shock absorber 12A, 12B connected to the frame of the motorcycle 1 and to the swingarm 4. In the embodiment shown in the appended figures, the motorcycle comprises in particular a first shock absorber 12A connected to the frame of the motorcycle 1 and the first arm 4A of the swingarm 4 and a second shock absorber 12B connected to the frame of the motorcycle 1 and to the second arm 4B of the swingarm 4. The motorcycle 1 comprises a disc brake 5,6 arranged on the side of the first arm 4A of the swingarm 4. The disc brake 5,6 comprises a brake disc 5 integral in rotation with the wheel 2, e.g., attached to the hub 19 of the wheel 2, and a brake caliper 6 attached to the swingarm 4.

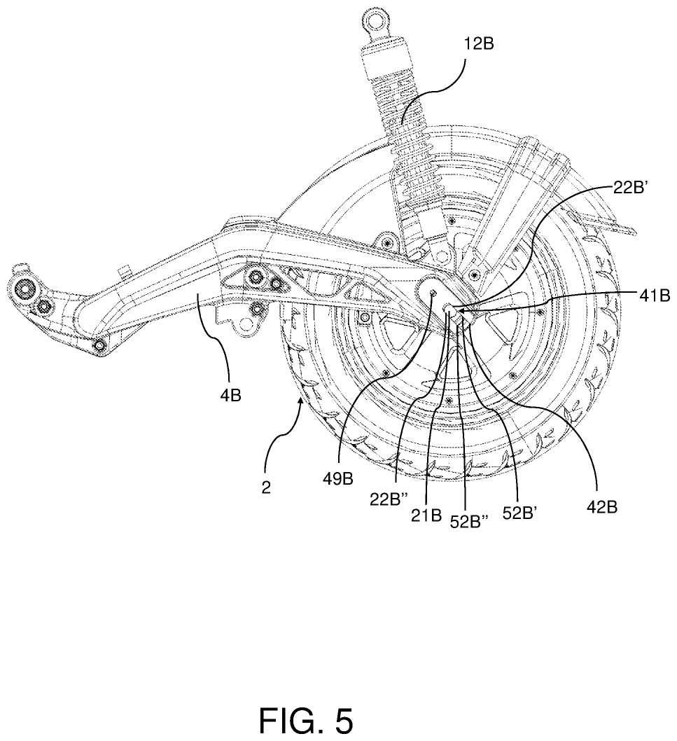

With reference to FIGS. 4-5, the first and second arms 4A,4B of the swingarm 4 comprise a first and second coupling recesses 41A,41B, respectively, which are configured to receive the first and second end portions 21A,21B of the axis 21, respectively. The first and second coupling recesses 41A,41B have each an open side 42A,42B to allow the axis 21 to be uncoupled from the swingarm 4 and the rear wheel 2 to be removed from the motorcycle 1. The first and second coupling recesses 41A, 41B extend according to a main extension direction X1 (FIG. 4). According to an embodiment, said main extension direction X1 is inclined relative to the ground so that the open sides 42A,42B of the first and second coupling recesses 41A,41B face towards the ground. As shown in the appended figures, according to an embodiment the first and second coupling recesses 41A,41B are straight recesses of the first and second arms 4A,4B. According to an embodiment, the direction X1 corresponds, in particular, to a direction of insertion and removal of the axis 21 into/from the coupling recesses 41A,41B.

Conveniently, the brake caliper 6 is angularly spaced about the axis 21 relative to the aforesaid main extension direction X1 so that the wheel 2 can be removed from the motorcycle 1 without the brake disc 5 mechanically interfering with the brake caliper 6. This makes it advantageously possible to remove the wheel 2 from the motorcycle 1 in a particularly easy manner without having to dismantle the brake caliper 6 first.

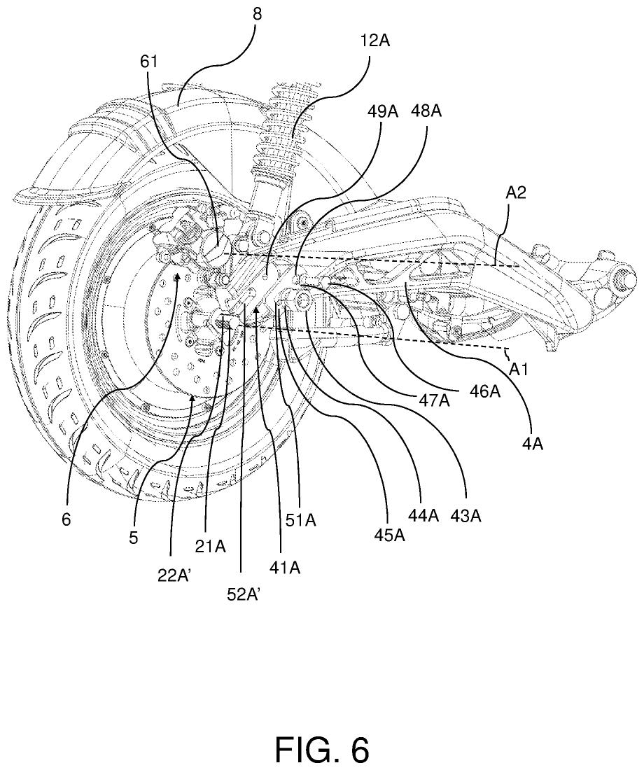

Referring to FIGS. 4 and 6, the axis 21 of the hub motor 20 has a first central geometric axis A1 corresponding to the rotation axis of the wheel 2. According to an embodiment, the brake caliper 6 comprises a caliper cylinder 61 capable of housing a piston (not shown and known in itself) of the brake caliper 6 (FIG. 6). The caliper cylinder 61 has a second central geometric axis A2 parallel to the first central axis A1. The central geometric axis A2 substantially corresponds to the symmetry axis of the caliper cylinder 61. According to a first embodiment, considering a first intersecting point P1 between the first central geometric axis A1 and a plane orthogonal to the first central geometric axis A1, and a second intersecting point P2 between the second central geometric axis A2 and the aforesaid plane orthogonal to axis A1, the brake caliper 6 is arranged so that a ray S1 exiting from the first intersecting point P1 and passing through the second intersecting point P2 forms an angle from 90° to 270°, extremes included, with a ray S2, parallel to or coincident with the aforesaid main extension direction X1 and lying on said plane orthogonal to axis A1, which exits from the first intersecting point P1 and is directed towards the open side 42A of said first coupling recess 41A. Clearly, as the aforementioned angle changes, it may be necessary to appropriately modify the configuration of the shock absorber 12A, if applicable, and/or the first arm 4A of the swingarm 4.

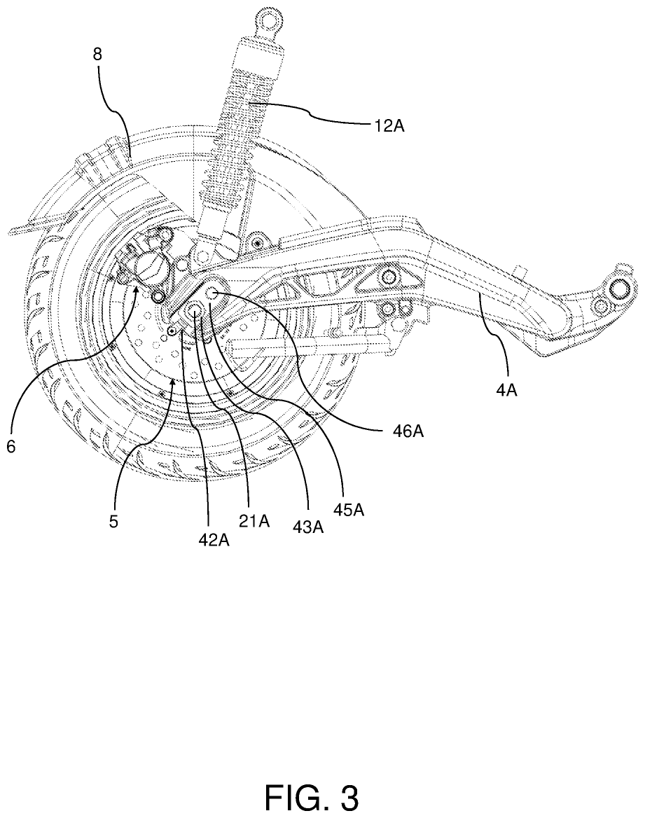

With reference to FIGS. 2, 3 and 6, according to an embodiment, the motorcycle 1 comprises fixing elements 43A,44A,43B configured to be coupled to the axis 21 so as to removably fix the axis 21 to the swingarm 4. According to an embodiment, the fixing elements 43A,44A,43B comprise first fixing elements 43A,44A and second fixing elements 43B configured to be coupled to the first end portion 21A and the second end portion 21B of the axis 21, respectively. According to an embodiment, the first fixing elements 43A,44A and the second fixing elements 43B comprise a first fixing nut 43A and a second fixing nut 43B, respectively. In this case, the first and second end portions 21A,21B will be provided with respective threads to allow the screwing of the fixing nuts 43A,43B. Preferably, a first nut washer 44A is associated with the first fixing nut 43A and a second nut washer (same as the nut washer 44A but not shown in the appended figures) is associated with the second fixing nut 43B. According to an embodiment, the motorcycle 1 comprises centering elements 45A,46A,47A,45B,46B configured to be removably mounted to the axis 21 and the swingarm 4 to allow for proper positioning of the axis 21. According to an embodiment, the centering elements 45A,46A,47A,45B,46B comprise first centering elements 45A, 46A,47A and second centering elements 45B,46B, respectively. The first centering elements 45A,46A,47A are configured to be mounted to the first arm 4A and the first end portion 21A of the axis 21. The second centering elements 45B,46B are configured to be mounted to the second arm 4B and the second end portion 21B of the axis 21. According to an embodiment, the first and second centering elements 45A,46A,47A,45B,46B respectively comprise first and second centering plates 45A,45B which are fixed to the first and second arms 4A,4B of the swingarm 4, respectively. Preferably, the first centering elements 45A,46A,47A and the second centering elements 45B,46B comprise first and second fixing screws 46A,46B, respectively, to fix the centering plates 45A,45B to the arms 4A,4B. Preferably, a first screw washer 47A is associated with the first fixing screw 46A and a second screw washer (same as washer 47A but not shown in the appended figures) is associated with the second fixing screw 46B. The first and second fixing screws 46A,46B are adapted to cross a first and second fixing holes 48A,48B provided in the first and second centering plates 45A,45B, respectively. Furthermore, the first and second fixing screws 46A,46B are configured to be screwed into first and second mounting holes 49A,49B, respectively (FIGS. 4 and 5) provided in the first and second arms 4A,4B of the swingarm 4, respectively. According to an embodiment, the first and second centering plates 45A,45B respectively comprise a first and second coupling openings 51A,51B which are configured to be crossed by the first and second end portions 21A,21B of the axis 21, respectively. In particular, the first and second coupling openings 51A,51B are countershaped relative to the profile of the first and second end portions 21A,21B. It is worth noting that, although the coupling opening 51B is covered by the second fixing nut 43B in FIG. 2, the coupling openings 51A and 51B are identical in shape in the illustrated example.

With reference to FIGS. 5-7, according to an embodiment, the first and second end portions 21A,21B of the axis 21 and the first and second coupling recesses 41A,41B, are configured so as to make it possible to guide the coupling and uncoupling of the axis 21 with the swingarm 4, preferably according to the aforementioned main extension direction X1. In particular, according to an embodiment, the first and second coupling recesses 41A,41B are each delimited by a pair of opposite flat guide walls 52A′,52A″ and 52B′,52B″. Furthermore, the first and second end portions 21A,21B of the axis 21 each comprise a pair of opposite flat faces 22A′,22A″ and 22B′,22B″. The pairs of opposite flat guiding walls 52A′,52A″ and 52B′,52B″ of the first and second coupling recesses 41A,41B are adapted to engage the pairs of opposite flat faces 22A′,22A″ and 22B′,22B″, respectively, to guide the sliding of the first and second end portions 21A,21B along the aforementioned main extension direction X1.

With reference to FIG. 4, according to an embodiment, the motorcycle 1 comprises a fender 8 associated with the rear wheel 2 and coupled to the swingarm 4. Preferably, the fender 8 entirely stands above the rear wheel 2. If the fender 8 is provided, the main extension direction X1 is such that the wheel 2 can be removed from the motorcycle 1 without the wheel 2, and more particularly the tire 2P of the wheel 2, mechanically interfering with the fender 8. In this manner, it is advantageously possible to remove the wheel 2 from the motorcycle 1 in a particularly easy way without having to remove the fender 8 first. Relative to the ray S1, the fender 8 is mainly arranged on the opposite side from the open sides 42A,42B of the recesses 41A,41B.

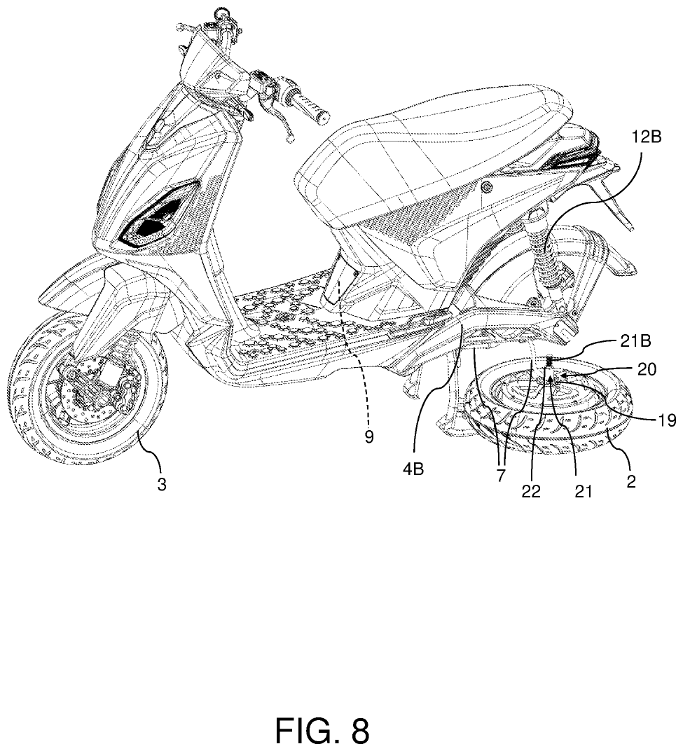

With reference to FIGS. 2 and 8, according to a convenient embodiment, the motorcycle 1 comprises a battery 9 (the battery 9 in the attached figures is covered by the body of the motorcycle 1) and an electrical cable 7 supplying power to the hub motor 20 which is connected to the battery 9 and the hub motor 20. In particular, the power supply cable 7 is arranged and has a length so as to make it possible to remove the wheel 2 from the motorcycle and arrange it next to the motorcycle 1 while remaining operatively connected to the battery 9 and to the hub motor 20. Advantageously, in this manner, it is possible to remove the wheel 2 from the motorcycle 1 without first having to disconnect the cable 7 from the battery 9. According to an embodiment, the power supply cable 7 is, in particular, arranged and has a length so as to make it possible to remove the wheel 2 from the motorcycle 1 and arrange it next to the motorcycle 1 while remaining operatively connected to the battery 9 and to the hub motor 20. According to an embodiment, the electrical power cable 7 extends at least partially below the second arm 4B of the swingarm 4.

According to an embodiment, the motorcycle 1 may comprise said fender 8 but not be provided with the disc brake 5,6. For example, according to an embodiment, the motorcycle 1 may comprise, as an alternative to the disc brake 5,6, a drum brake (not shown) associated with the wheel 2 which does not create an impediment to the removal of the wheel 2. If the disc brake 5,6 is not provided in the motorcycle 1, advantageously the main extension direction X1 of the first and second coupling recesses 41A,41B is in any case such as to allow the wheel 2 to be removed from the motorcycle 1 without the wheel 2, and more particularly the tire 2P of the wheel 2, mechanically interfering with the fender 8.

Having described the structure of a motorcycle 1, a method of removing the rear wheel 2 is now described by way of non-limiting example with reference to the embodiment form illustrated in the appended figures.

Assuming that the motorcycle 1 is initially in the configuration shown in FIGS. 1-2, it will first be necessary to remove the centering plates 45A,45B to remove wheel 2 from motorcycle 1. To do this, it will be necessary to unscrew the fixing nuts 43A,43B from the first and second end portions 21A,21B of the axis 21 and unscrew the fixing screws 46A,46B from the first and second arms 4A,4B of the swingarm 4 (FIGS. 4-5). After removing the centering plates 45A,45B, it will then be sufficient to pull the wheel 2 in the direction X1 towards the open sides 42A,42B of the coupling recesses 41A,41B so as to slide the end portions 21A,21B of the axis 21 through the coupling recesses 41A,41B until the axis 21 is completely uncoupled from the swingarm 4 (FIGS. 6-7). Preferably, once removed from the swingarm 4, the rear wheel 2 may be arranged alongside the motorcycle 1 without having to disconnect the power cable 7 from the battery 9. After removal, the wheel 2 can be refitted to the swingarm 4 by performing, in reverse order, the operations described above for removing wheel 2.

Based on the explanation above, it is thus possible to understand how a motorcycle of the type described above allows to achieve the purposes indicated above with reference to the prior art.

Without prejudice to the principle of the disclosure, the embodiments and the manufacturing details may be broadly varied relative to the above description disclosed by way of a non-limiting example, without departing from the scope of the disclosure as defined in the appended claims.

1. A motorcycle comprising:
a rear wheel with hub motor, said hub motor comprising a hub motor axis having first and second opposite end portions;
a swingarm comprising a first and a second arm;
a disc brake (5,6), arranged on the side of the first arm of the swingarm, comprising a braking disc rotationally integral with said wheel and a brake caliper fixed to said swingarm,
wherein the first and second arms of the swingarm comprise a first and second coupling recesses, respectively, which are configured to receive the first and second end portions of the hub motor axis, respectively, and have each an open side to allow to uncouple the hub motor axis from said swingarm and remove said wheel from the motorcycle, wherein said first and second coupling recesses extend according to a main extension direction which is inclined relative to the ground so that said open sides face the ground, wherein the brake caliper is angularly spaced about the hub motor axis relative to said main extension direction so as to allow to remove said wheel from said motorcycle without the brake disc mechanically interfering with the brake caliper.

2. A motorcycle according to claim 1, wherein the hub motor axis has a first central geometric axis corresponding to the rotation axis of said wheel, wherein the brake caliper comprises a caliper cylinder adapted to accommodate a piston of the brake caliper, said caliper cylinder has a second central geometric axis parallel to said first central axis, wherein, having considered a first intersecting point between the first central geometric axis and a plane orthogonal to the first central geometric axis, and a second intersecting point between the second central geometric axis and said orthogonal plane, the brake caliper is arranged so that a ray exiting from the first intersecting point and passing through the second intersecting point forms an angle from 90° to 270°, extremes included, with a ray, parallel to or coincident with said main extension direction and lying on said orthogonal plane, which exits from the first intersecting point and is directed towards the open side of said first coupling recess.

3. A motorcycle according to claim 1, wherein said first and second coupling recesses are straight recesses of said first and second arms of the swingarm.

4. A motorcycle according to claim 1, comprising a fender associated with said wheel, wherein said main extension direction is such as to allow to remove said wheel from said motorcycle without said wheel mechanically interfering with the fender.

5. A motorcycle according to claim 1, comprising a battery and a power supply cable of the hub motor which is connected to the battery and to the hub motor, wherein the power supply cable is arranged and has a length so as to allow to remove said wheel from the motorcycle while remaining operatively connected to the battery and to the hub motor.

6. A motorcycle according to claim 5, wherein said power supply cable is arranged and has a length so as to allow to remove the wheel from the motorcycle and arrange it next to the motorcycle while remaining operatively connected to the battery and to the hub motor.

7. A motorcycle according to claim 4, wherein said fender entirely stands above said wheel.

8. A motorcycle according to claim 5, wherein said power supply cable at least partially extends below the second arm of the swingarm.

9. A motorcycle comprising:
a rear wheel with hub motor, said hub motor comprising a hub motor axis having first and second opposite end portions;
a swingarm comprising a first and a second arm;
a fender associated with said wheel and coupled to the swingarm;
wherein the first and second arms of the swingarm comprise a first and second coupling recesses, respectively, which are configured to receive the first and second end portions of the hub motor axis, respectively, and have each an open side to allow to uncouple the hub motor axis from said swingarm and remove said wheel from the motorcycle, wherein said first and second coupling recesses have a main extension direction such as to allow to remove said wheel from said motorcycle without said wheel mechanically interfering with the fender.

10. A motorcycle according to claim 9, wherein the hub motor axis has a first central geometric axis corresponding to the rotation axis of said wheel, wherein the brake caliper comprises a caliper cylinder adapted to accommodate a piston of the brake caliper, said caliper cylinder has a second central geometric axis parallel to said first central axis, wherein, having considered a first intersecting point between the first central geometric axis and a plane orthogonal to the first central geometric axis, and a second intersecting point between the second central geometric axis and said orthogonal plane, the fender is mainly arranged on the opposite side of the ray joining the intersection points (P1,P2) relative to the open sides (42A,42B) of the recesses (41A,41B).
